(19) United States
(12) Patent Application Publication
(10) Pub. No.: US 2018/0277063 A1
(43) Pub. Date: Sep. 27, 2018

(54) Solar Powered Display Assembly

(71) Applicant: Jessica Augustyniak, Elizabeth, NJ (US)

(72) Inventor: Jessica Augustyniak, Elizabeth, NJ (US)

(21) Appl. No.: 15/468,262

(22) Filed: Mar. 24, 2017

(51) Int. Cl. G09G 5/36; H02S 20/23; H02S 99/00; G09F 9/30; G09F 23/00

(52) U.S. Cl. CPC G09G 5/36; H02S 20/23; H02S 99/00; G09G 2330/02; G09F 23/00; G09G 2330/04; G09F 9/30

(57) ABSTRACT

A solar powered display assembly for publicly displaying a selected image includes a panel that is selectively coupled to a support surface. A solar array is positioned on the panel such that the solar array is exposed to sunlight. A display unit is coupled to the solar array to project a selected image outwardly from the panel. The display unit is comprised of a translucent material such that the display unit passes sunlight therethrough to the solar array. Moreover, the display unit is electrically coupled to the solar array.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to display devices and more particularly pertains to a new display device for publicly displaying a selected image.

### BRIEF SUMMARY OF THE INVENTION

An embodiment of the disclosure meets the needs presented above by generally comprising a panel that is selectively coupled to a support surface. A solar array is positioned on the panel such that the solar array is exposed to sunlight. A display unit is coupled to the solar array to project a selected image outwardly from the panel. The display unit is comprised of a translucent material such that the display unit passes sunlight therethrough to the solar array. Moreover, the display unit is electrically coupled to the solar array.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a solar powered display assembly according to an embodiment of the disclosure.

FIG. 2 is a bottom view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a schematic view of an embodiment of the disclosure.

### DETAILED DESCRIPTION OF THE INVENTION

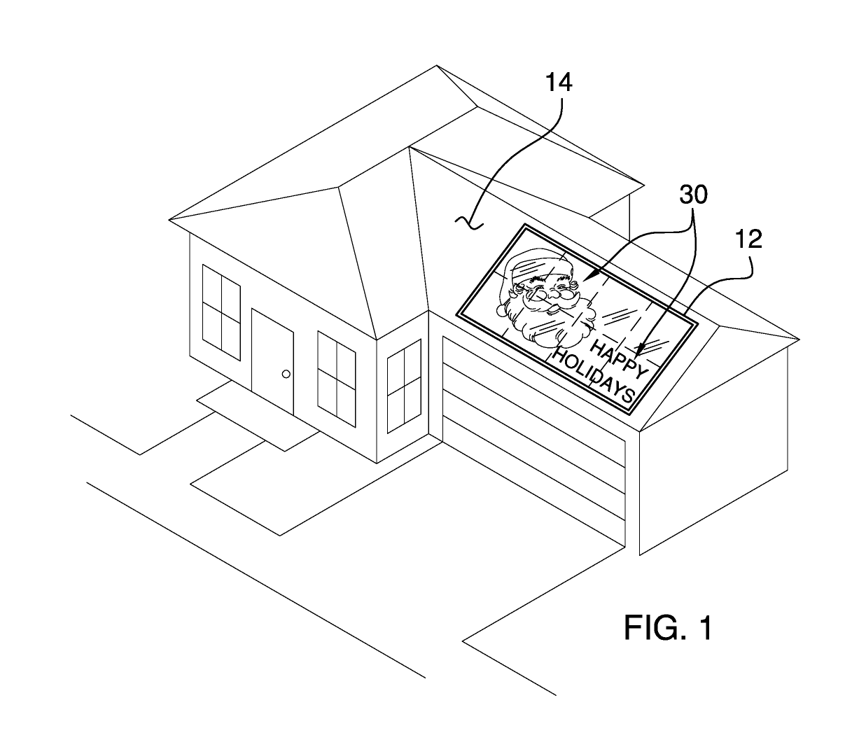

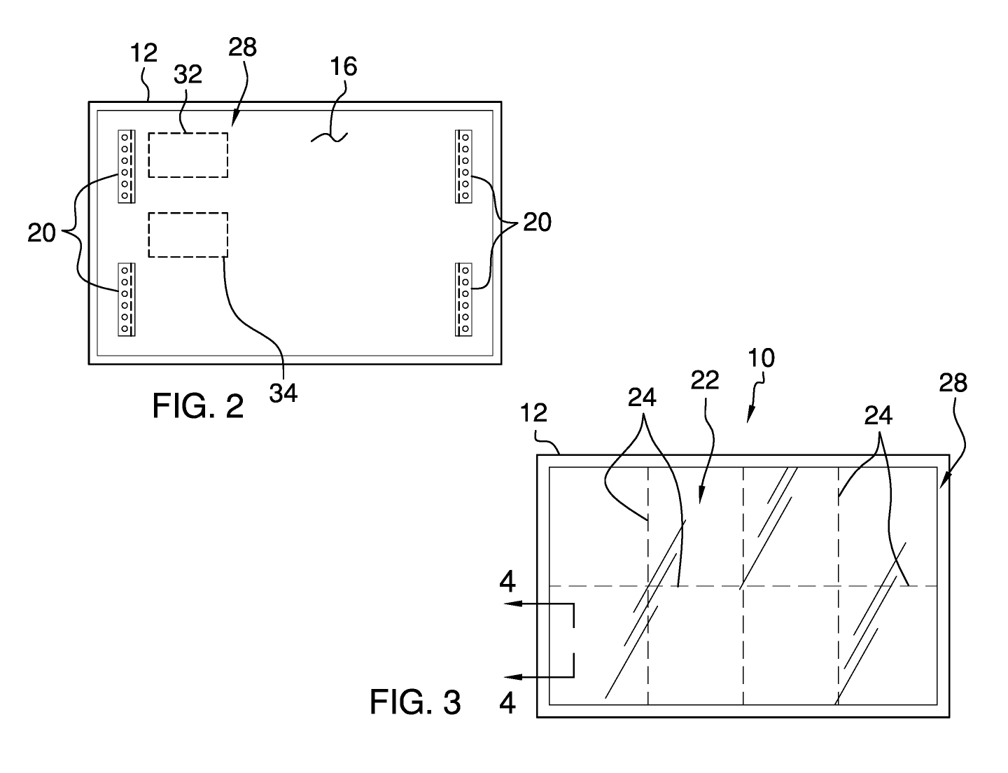

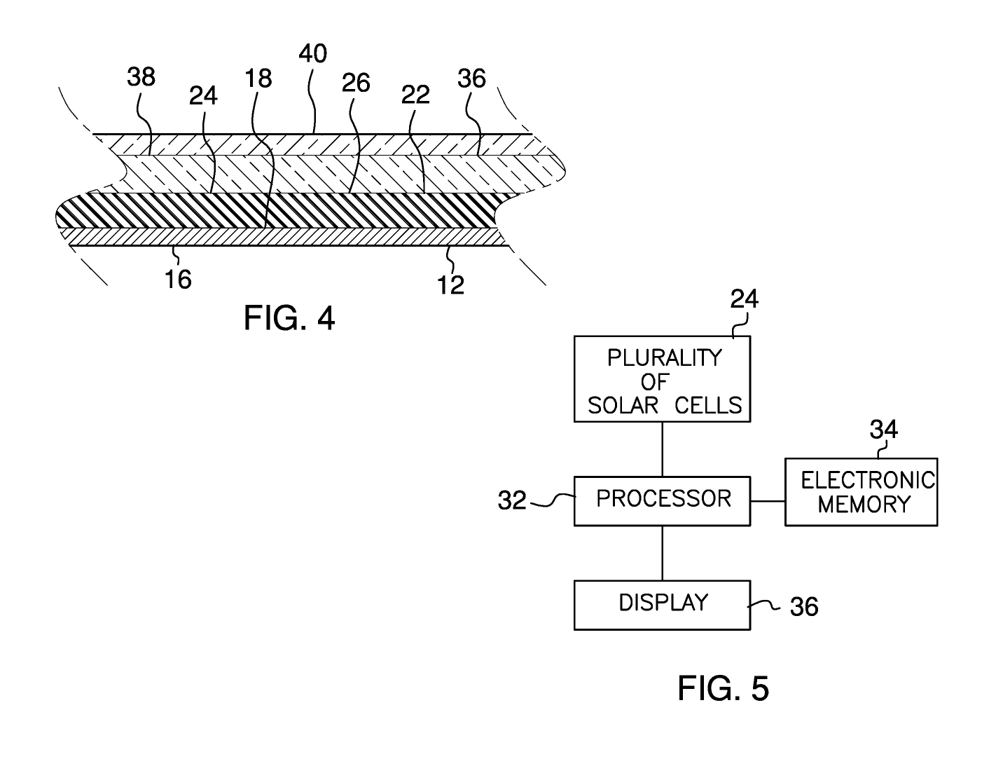

With reference now to the drawings, and in particular to FIGS. 1 through 5 thereof, a new display device embodying the principles and concepts of an embodiment of the disclosure and generally designated by the reference numeral 10 will be described.

As best illustrated in FIGS. 1 through 5, the solar powered display assembly 10 generally comprises a panel 12 that is selectively coupled to a support surface 14. The support surface 14 may be a roof of a building, a billboard or any other support surface 14 that is visible to the public. The panel 12 has a first surface 16 and a second surface 18. Moreover, the first surface 16 is positioned on the support surface 14. The panel 12 may have a length ranging between approximately 3.0 meters and 6.0 meters.

A plurality of mounts 20 is provided and each of the mounts 20 is coupled to the first surface 16 of the panel 12. Each of the mounts 20 engages the support surface 14 thereby facilitating the panel 12 to be retained on the support surface 14. Each of the mounts 20 may include a plurality of fasteners or the like and each of the fasteners may engage the support surface 14. Additionally, each of the mounts 20 may be a mechanical fastening mount of any conventional design.

A solar array 22 is provided and the solar array 22 is positioned on the panel 12 thereby facilitating the solar array 22 to be exposed to sunlight. The solar array 22 comprises a plurality of solar cells 24 and each of the solar cells 24 is coupled to the second surface 18 of the panel 12. The solar cells 24 are distributed to substantially cover the second surface 18 and each of the solar cells 24 has an outwardly facing surface 26.

A display unit 28 is provided and the display unit 28 is coupled to the solar array 22. The display unit 28 projects a selected image 30 outwardly from the panel 12. In this way the display 36 communicates the image 30 to the public for the purposes of advertising, promotion or other means of mass communication. The display unit 28 is comprised of a translucent material such that the display unit 28 passes sunlight therethrough to the solar array 22. The display unit 28 is electrically coupled to the solar array 22 such that the solar array 22 powers the display unit 28.

The display unit 28 comprises a processor 32 that is coupled to the panel 12 and the processor 32 is electrically coupled to each of the solar cells 24. The processor 32 may be an electronic processor 32 or the like. An electronic memory 34 is coupled to the panel 12 and the electronic memory 34 is electrically coupled to the processor 32. The electronic memory 34 stores data pertaining to the selected image 30 and the electronic memory 34 may comprise RAM memory, a hard disk drive or any other type of electronic data storage. The selected image 30 may a still image, a video or any other type of electronic image. An input port may be coupled to the panel 12 and the input port may be electrically coupled to the processor 32. Moreover, the input port may be electrically coupled to an extrinsic electronic device for downloading the data from the extrinsic electronic device.

A display 36 is coupled to the outwardly facing surface corresponding to each of the solar cells 24. The display 36 is electrically coupled to the processor 32 such that the display 36 receives the data from the electronic memory 34. In this way the display 36 selectively displays the selected image 30. The display 36 is comprised of a translucent material configured to pass sunlight therethrough to the solar cells 24. In this way the display 36 does not inhibit the solar cells 24 from converting solar energy into electrical energy. The display 36 has an outwardly facing surface 38 and the display 36 may comprise a translucent OLED or the like. A window 40 is coupled to the outwardly facing surface of the display 36 to protect the display 36 from impact damage.

In use, the panel 12 is coupled to the support surface 14 having each of the solar array 22 and the display unit 28 being exposed. Each of the solar cells 24 converts solar energy into electrical energy to power the display unit 28. The display 36 receives the data from the electronic memory 34 and the display 36 displays the selected image 30. In this way the display 36 communicates the selected image 30 to the public while the solar array 22 powers the display unit 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered display assembly being configured to display a selected image for the purpose of mass communication, said assembly comprising:
a panel being configured to be coupled to a support surface;
solar array being positioned on said panel wherein said solar array is configured to be exposed to sunlight; and
a display unit being coupled to said solar array wherein said display unit is configured to project a selected image outwardly from said panel, said display unit being comprised of a translucent material wherein said display unit is configured to pass sunlight therethrough to said solar array, said display unit being electrically coupled to said solar array.

2. The assembly according to claim 1, wherein:
said panel has a first surface and a second surface, said first surface being configured to be positioned on said support surface; and
said panel has a plurality of mounts, each of said mounts being coupled to said first surface of said panel, each of said mounts being configured to engage the support surface thereby facilitating said panel to be retained on the support surface.

3. The assembly according to claim 2, wherein said solar array comprises a plurality of solar cells, each of said solar cells being coupled to said second surface of said panel, said solar cells being distributed to substantially cover said second surface, each of said solar cells having an outwardly facing surface.

4. The assembly according to claim 1, wherein:
said solar array includes a plurality of solar cells; and
said display unit comprises a processor being coupled to said panel, said processor being electrically coupled to each of said solar cells.

5. The assembly according to claim 4, further comprising an electronic memory being coupled to said panel, said electronic memory being electrically coupled to said processor, said electronic memory storing data pertaining to the selected image.

6. The assembly according to claim 5, wherein:
each of said solar cells has an outwardly facing surface; and
said display unit includes a display being coupled to said outwardly facing surface corresponding to each of said solar cells, said display being electrically coupled to said processor such that said display receives the data from said electronic memory wherein said display is configured to display the selected image, said display being comprised of a translucent material wherein said display is configured to pass sunlight therethrough to said solar cells, said display having an outwardly facing surface.

7. The assembly according to claim 6, further comprising a window being coupled to said outwardly facing surface of said display wherein said window is configured to protect said display from impact damage.

8. A solar powered display assembly being configured to display a selected image for the purpose of mass communication, said assembly comprising:
a panel being configured to be coupled to a support surface, said panel having a first surface and a second surface, said first surface being configured to be positioned on said support surface;
a plurality of mounts, each of said mounts being coupled to said first surface of said panel, each of said mounts being configured to engage the support surface thereby facilitating said panel to be retained on the support surface;
solar array being positioned on said panel wherein said solar array is configured to be exposed to sunlight, said solar array comprising a plurality of solar cells, each of said solar cells being coupled to said second surface of said panel, said solar cells being distributed to substantially cover said second surface, each of said solar cells having an outwardly facing surface; and
a display unit being coupled to said solar array wherein said display unit is configured to project a selected image outwardly from said panel, said display unit being comprised of a translucent material wherein said display unit is configured to pass sunlight therethrough to said solar array, said display unit being electrically coupled to said solar array, said display unit comprising:
a processor being coupled to said panel, said processor being electrically coupled to each of said solar cells,
an electronic memory being coupled to said panel, said electronic memory being electrically coupled to said processor, said electronic memory storing data pertaining to the selected image,
a display being coupled to said outwardly facing surface corresponding to each of said solar cells, said display being electrically coupled to said processor such that said display receives the data from said electronic memory wherein said display is configured to display the selected image, said display being comprised of a translucent material wherein said display is configured to pass sunlight therethrough to said solar cells, said display having an outwardly facing surface, and
a window being coupled to said outwardly facing surface of said display wherein said window is configured to protect said display from impact damage.
